(19) United States
(12) Patent Application Publication
(10) Pub. No.: US 2016/0092102 A1
(43) Pub. Date: Mar. 31, 2016

(54) Smartphone screen touch round keyboard with or without swift, with or without vowels

(71) Applicant: Georgeta Costina Johnson, Flagstaff, AZ (US)

(72) Inventor: Georgeta Costina Johnson, Flagstaff, AZ (US)

(21) Appl. No.: 14/497,131

(22) Filed: Sep. 25, 2014

(51) Int. Cl. G06F 3/0488; G06F 3/0486

(52) U.S. Cl. CPC G06F 3/04886; G06F 3/04883; G06F 3/0486

(57) ABSTRACT

This software system allow smartphone users to type words using a round keyboard containing the letters of the alphabet, numerals and special characters (including emoji).

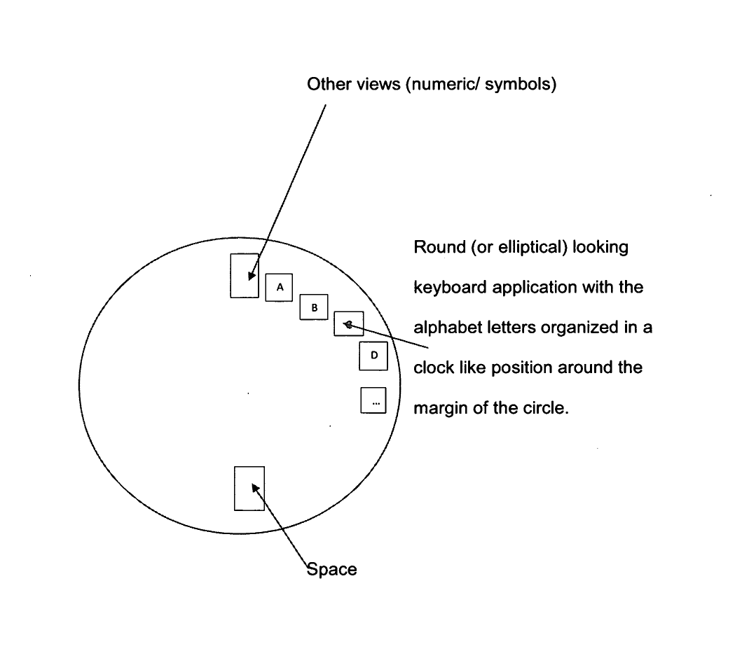

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM

Not Applicable

### LISTING COMPACT DISC APPENDIX

Not Applicable

### BACKGROUND OF THE INVENTION

### Purpose

The purpose of this document is to present a detailed description of the Smartphone screen touch round keyboard with or without swift, with or without vowels. It will explain the purpose and features of the system, the interfaces of the system, what the system will do, the constraints under which it must operate and how the system will react to external stimuli. This document is intended for patent submittal.

### GLOSSARY

| Term | Definition |
|---|---|
| Software Requirements | A document that completely describes all of the |
| Specification | functions of a proposed system and the |
| | constraints under which it must operate. For |
| | example, this document. |
| User | A person using the keyboard |

### REFERENCES

IEEE. IEEE Std 830-1998 IEEE Recommended Practice for Software Requirements Specifications. IEEE Computer Society, 1998.

### OVERVIEW OF DOCUMENT

The next chapter, the Overall Description section, of this document gives an overview of the functionality of the software. It describes the informal requirements and is used to establish a context for the technical requirements specification in the next chapter.

The chapter “Requirements Specification” of this document is written primarily for the developers and describes in technical terms the details of the functionality of the product.

Both sections of the document describe the same software product in its entirety, but are intended for different audiences and thus use different language. This document does not contain the specification for the reporting section of the system.

### DETAILED DESCRIPTION

The process has one active actor that is the user

### Functional Requirements Specifications

This section outlines the use cases for each activity or interaction user with the software.

### Opening Keyboard

### BRIEF DESCRIPTION

User opens the keyboard application to type a text into a messaging application or any office type applications or any other application that requires the user to type in.

### Initial Step-by-Step Description

Before this use case can be initiated, the application must be installed.

Xref: Opening keyboard

### Typing Text

User starts typing text by swiping its finger between the letters on the keyboard, arranged in a round pattern. An extra character on the keyboard substitutes “space”. The learning algorithm in behind application uses text predictability to substitute groups of latters with words e.g. “ill” with “I'll” The keyboard application has a settings view where the user can configure the group letter replacement pattern.

There is an extra button to switch between alpha and numeric or emoji view.

### Non-Functional Requirements

The system will be installed on the end user device. Because of the short distance between the characters the typing speed will increase.

### Functional Requirements

The Logical Structure of the Data is contained in Section 3.3.1.

### Opening Keyboard

| | |
|---|---|
| Use Case Name | Opening keyboard |
| XRef | Section 2.2.1, Opening keyboard |
| Trigger | User needs to type a text into its device |
| Precondition | Application must be installed |
| Basic Path | By touching the text place on the document or |
| | application that needs to be typed in. The keyboard |
| | application comes up front covering partial the screen. |
| Alternative Paths | N/A |
| Postcondition | The user is ready to start typing |
| Exception Paths | none |
| Other | None |

### Typing Text

| | |
|---|---|
| Use Case Name | Typing text |
| XRef | Section 2.2.2, Typing text |
| Trigger | The application is opened and user ready to start |
| | typing |
| Precondition | User had opened the applications |
| Basic Path | User starts to swipe its finger between the latters on |
| | the screen, touching the space character and |
| | switching between alpha, numeric, special characters |
| | or emoji view. As the words are typed the typed text |
| | appears on the visible part of the application receiving |
| | the text. |
| Alternative Paths | N/A |
| Postcondition | The text is visible in the receiving applications |
| Exception Paths | None. |
| Other | None |

### Security

This application does not need access to any of the secure sections of a smartphone device.

### SUMMARY OF INVENTION

This software system allow smartphone users to type words using a round keyboard containing the letters of the alphabet, numerals and special characters (including emoji). This would improve speed of typing and provide an alternative to the traditional typing

### REFERENCE TO DRAWINGS

One front view of how the application is designed and how users would see it.

1. The invention claimed is “Smartphone screen touch round keyboard with or without swift, with or without vowels software (or the equivalent)”. I Georgeta Johnson claim “Smartphone screen touch round keyboard with or without swift, with or without vowels software (or the equivalent)”, which is a smartphone software application that is an alternative to the classical QWERTZ keyboard application. The application opens whenever the user of the smartphone where the application is installed, taps (all smartphones targeted are equipped with a touch screen) the field where the user wants to enter text or numerals. Responding to the tap “Smartphone screen touch round keyboard with or without swift, with or without vowels software (or the equivalent)” opens presenting the user with the alphabet arranged (alphabetically or not<I Georgeta Johnson claim all the alphabet arrangements on a round/elliptical keyboard) in a circle or elliptical form, with a space symbol and a symbol for numerical characters/emoji. The user uses a finger to tap on each letter forming a word or, alternatively, keeps its finger on the screen, dragging it between letters, forming a word. The “Smartphone screen touch round keyboard with or without swift, with or without vowels software (or the equivalent)” is based on an internal dictionary of words and an algorithm for continuous search in this dictionary for the best 1, 2 or more matches (this is a setting the user can set up, or use the default setting of 1 match). The first match would be entered in the field where the user intended the text to be entered. If the “Smartphone screen touch round keyboard with or without swift, with or without vowels software (or the equivalent)” settings are set to more than one word match, there would be an additional text box appearing under the filed intended by the user to receive text and in top (below, left right or hovering onto) of the round keyboard application. With a tap on any of the other word matches the user can change the word in the field intended to receive text to the word tapped. After the user accepts the matched word as is intended word, the user moves to a new word either tapping the space or by setting a setting of the “Smartphone screen touch round keyboard with or without swift, with or without vowels software (or the equivalent)’ to automatically insert a space after each entered word. The user continues to enter the text until finished then closes the “Smartphone screen touch round keyboard with or without swift, with or without vowels software” (or the equivalent) by pressing the back button embedded in the smartphone. Alternatively, for models that don't have a back button the “Smartphone screen touch round keyboard with or without swift, with or without vowels software” (or the equivalent) is equipped with a back button of its own. The “Smartphone screen touch round keyboard with or without swift, with or without vowels software” (or the equivalent) has a setting section where the user can set various settings including but not limited to: the back and front color of the keyboard, whatever a sound should be played when the user touches the keyboard, the number of matches presented by the application, if a space should be automatically added after a word, if the space symbol should be visible on the “Smartphone screen touch round keyboard with or without swift, with or without vowels software” (or the equivalent) or if the “Smartphone screen touch round keyboard with or without swift, with or without vowels software” (or the equivalent) should present the user entire alphabet or only consonants. I Georgeta Johnson, claim all of the above, as described in the claim section of this document specifically and in the rest of the document generally.
